(19) United States
(12) Patent Application Publication
(10) Pub. No.: US 2014/0231421 A1
(43) Pub. Date: Aug. 21, 2014

(54) COOKER

(71) Applicant: SAMSUNG ELECTRONICS CO., LTD., Suwon-si (KR)

(72) Inventors: Sung Pyo YANG, Yongin-si (KR); Pung Yeun CHO, Suwon-si (KR); Han Seong KANG, Hwasung-si (KR); Hyung jin KIM, Ansan-si (KR)

(73) Assignee: SAMSUNG ELECTRONICS CO., LTD., Suwon-si (KR)

(21) Appl. No.: 14/182,663

(22) Filed: Feb. 18, 2014

(30) Foreign Application Priority Data
Feb. 18, 2013 (KR) 10-2013-0016686

(51) Int. Cl. H05B 6/64

(52) U.S. Cl. CPC H05B 6/6408
USPC 219/763

(57) ABSTRACT

A cooker capable of fixing a rail assembly to the inside of a cooking compartment by a fixing device includes a cooking compartment in which food is placed for cooking, a fixing bracket mounted at an inner wall of the cooking compartment, a rack provided so as to be withdrawn from the cooking compartment, a rail assembly mounted on the rack and enabling the rack to be inserted and withdrawn from the cooking compartment, and a locking device mounted on the rail assembly, and having one side locked with the fixing bracket such that the rail assembly is fixed without being moved inside the cooking compartment.

### CROSS-REFERENCE TO RELATED APPLICATIONS

This application claims the benefit of Korean Patent Application No. 10-2013-0016686, filed on Feb. 18, 2013, in the Korean Intellectual Property Office, the disclosure of which is incorporated herein by reference.

### BACKGROUND

1. Field

One or more embodiments relate to a cooker having a rail assembly provided with a fixing device configured to the rail assembly to be fixed to the inside of the cooker.

2. Description of the Related Art

In general, a cooker is a home appliance to cook food. The cooker serves to heat and cook food by use, for example, of heat or microwaves generated from a heater or a magnetron.

As for the cooker, a tray, on which food is placed, is inserted or withdrawn into/from a cooking compartment by being guided by a rail assembly. The rail assembly includes a fixing rail fixed to the cooking compartment, and a moving rail configured to slide along the fixing rail while being coupled to the tray. The moving rail may include a first moving rail and a second moving rail. As the rack is withdrawn by way of the first moving rail and the second moving rail, the length of the rack withdrawn is increased. Accordingly, a user may able to completely withdraw the rack outside the cooking compartment, which facilitates the insertion and/or withdrawal of the food.

In the conventional technology, the fixing rail may be fixed by a locking device while being accommodated in an inside space of the cooking compartment. In detail, a locking part in the form of a bead is formed at one side of an inner surface forming the cooking compartment in a protruding manner, and the locking device of the fixing rail is fixed by being locked with the locking part in the form of the bead. Since the inner surface forming the cooking compartment is manufactured by coating ceramic material, if the rack is repetitively inserted or withdrawn, a portion corresponding to the locking part may be broken and thus the quality of the product may be degraded.

### SUMMARY

One or more embodiments relate to a cooker that may be capable of preventing an inner wall forming a cooking compartment from being damaged if a rack is repetitively inserted or withdrawn.

One or more embodiments relate to a cooker that may have a rack, once withdrawn, fixed in a state of being withdrawn without returning to the inside of the cooking compartment due to various factors, such as, for example, an inclination of a bottom surface on which the cooker is provided.

Additional aspects and/or advantages of one or more embodiments will be set forth in part in the description which follows and, in part, will be apparent from the description, or may be learned by practice of one or more embodiments of disclosure. One or more embodiments are inclusive of such additional aspects.

The foregoing described problems may be overcome and/or other aspects may be achieved by one or more embodiments of a cooker that may include a cooking compartment, a fixing bracket, a rack, a rail assembly and a locking device. The cooking compartment may enable food to be inserted therein for cooking. The fixing bracket may be mounted at an inner wall of the cooking compartment. The rack may be provided so as to be withdrawn from the cooking compartment. The rail assembly may be mounted on the rack, and may enable the rack to be inserted and withdrawn from the cooking compartment. The locking device may be mounted on the rail assembly, and may have one side locked with the fixing bracket such that the rail assembly may be fixed without being moved inside the cooking compartment.

The cooking compartment may be formed by a back plate located at a rear side and side plates located at both sides.

The fixing bracket may be mounted at the side plate.

The fixing bracket may include a coupling part mounted at the side plate, and a fixing part extending from the coupling part.

The fixing part may be formed by being bent from the coupling part, and may be provided in a plurality of units thereof being spaced apart from one another.

The locking device may include a head part, which may extend from a body part of the locking device and may be provided at a lower portion thereof with an inclination part.

The inclination part may slidably pass through the fixing part as the rail assembly is slid to inside the cooking compartment, and the rail assembly may be fixed as the head part is disposed at a rear side of the fixing part.

An elastic member may be mounted on the rail assembly, and the elastic member may transmit an elastic force to the locking device, thereby possibly fixing the locking device.

The rail assembly may be provided with a rotating shaft, and the body part may be formed with a hole allowing the rotating shaft to be inserted thereinto.

The locking device may be provided with an interference part that may extend from a lower portion of the body part, and if the rail assembly is slid to a rear side in a state of being fixed to the inside of the cooking compartment by the locking device, the locking device may rotate on the rotating shaft to allow the interference part to be slid to an upper side of the fixing part, and the head part may be located between fixing parts adjacent to each other.

The rack may be withdrawn from the cooking compartment by pulling the rail assembly to a front side of the cooking compartment in a state in which the head part is located between the fixing parts adjacent to each other.

The rail assembly may include a fixing rail, an intermediate rail configured to slide while being mounted on the fixing rail, and a moving rail configured to slide while being mounted on the intermediate rail.

A bearing may be mounted on at least one of the fixing rail, the intermediate rail and the moving rail, and a protrusion may be formed on another one of the fixing rail, the intermediate rail and the moving rail that is slid while coming into contact with the at least one of the fixing rail, the intermediate rail and the moving rail which has the bearing.

The locking device may be coupled to the fixing rail, and the rack may be mounted on the moving rail.

The side plate may be provided with a rail mounting part protruding in a front and rear side direction, and the rail assembly may be slid along the rail mounting part.

The fixing part may be provided to correspond to the rail mounting part, and if the rail assembly is slidably inserted along the rail mounting part, the locking device may be locked with the fixing part.

The foregoing described problems may be overcome and/or other aspects may be achieved by one or more embodiments of a cooker that may include a cooking compartment, a fixing rail, an intermediate rail, a moving rail, a fixing bracket, and a locking device. The cooking compartment may form a space in which food is input for cooking. The fixing rail may be configured to slide while coming into contact with an inner wall of the cooking compartment. The intermediate rail may be configured to slide while being mounted on the fixing rail. The moving rail may be configured to slide while being mounted on the intermediate rail. The fixing bracket may be mounted on the inner wall of the cooking compartment, and may include a plurality of fixing parts provided while being spaced apart from an inner wall that is located at a rear side of the cooking compartment. The locking device may be mounted on the fixing rail, and may be configured to fix the fixing rail by being interfered with the fixing part.

The fixing rail may be provided with a rotating shaft formed in a protruding manner, and the locking device may be mounted so as to rotate on the rotating shaft.

An elastic member may be mounted on the fixing rail so as to provide the locking device with a downward elastic force, thereby possibly preventing the locking device from being moved.

A bearing may be mounted on at least one of the fixing rail, the intermediate rail and the moving rail, and a protrusion may be formed on another one of the fixing rail, the intermediate rail and the moving rail that is slid while coming into contact with the at least one of the fixing rail, the intermediate rail and the moving rail which has the bearing.

As described above, the cooker may have a rack, which may be completely accommodated inside of a cooking compartment and may be fixed, and may be separately provided with a fixing bracket, to which a locking device of the rack may be locked and which may be mounted on an inner wall of the cooking compartment, so as to possibly prevent the inner wall forming the cooking compartment from being damaged if the rack is repetitively inserted and withdrawn. The rack may be fixed in a state of being withdrawn, thereby enabling a user to place food on the rack and to take out the food when cooking is completed.

### BRIEF DESCRIPTION OF THE DRAWINGS

These and/or other aspects will become apparent and more readily appreciated from the following description of embodiments, taken in conjunction with the accompanying drawings of which:

FIG. 1 is a perspective view illustrating a rack being accommodated inside a cooking compartment in accordance with one or more embodiments.

FIG. 2 is a perspective view illustrating the rack being withdrawn from the cooking compartment in accordance with one or more embodiments.

FIG. 3 is an exploded perspective view illustrating a rail assembly in accordance with one or more embodiments.

FIG. 4 is a drawing illustrating a locking device in accordance with one or more embodiments.

FIG. 5 is a drawing illustrating a fixing bracket in accordance with one or more embodiments.

FIG. 6 is a drawing illustrating the locking device accessing the fixing bracket in accordance with one or more embodiments.

FIG. 7 is a drawing illustrating the locking device fixed by being locked with the fixing bracket in accordance with one or more embodiments.

FIG. 8 is a drawing illustrating the locking device being released from being fixed to the fixing bracket in accordance with one or more embodiments.

FIG. 9 is a drawing illustrating a protrusion formed at the rail assembly in accordance with one or more embodiments.

### DETAILED DESCRIPTION

Reference will now be made in detail to one or more embodiments, illustrated in the accompanying drawings, wherein like reference numerals refer to like elements throughout. In this regard, embodiments of the present invention may be embodied in many different forms and should not be construed as being limited to embodiments set forth herein, as various changes, modifications, and equivalents of the systems, apparatuses and/or methods described herein will be understood to be included in the invention by those of ordinary skill in the art after embodiments discussed herein are understood. Accordingly, embodiments are merely described below, by referring to the figures, to explain aspects of the present invention.

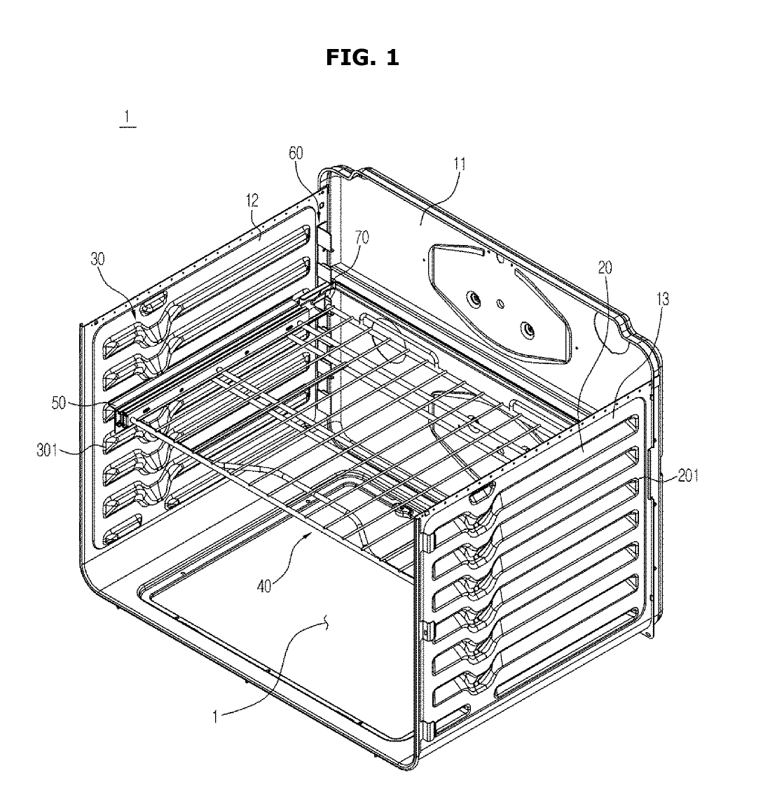

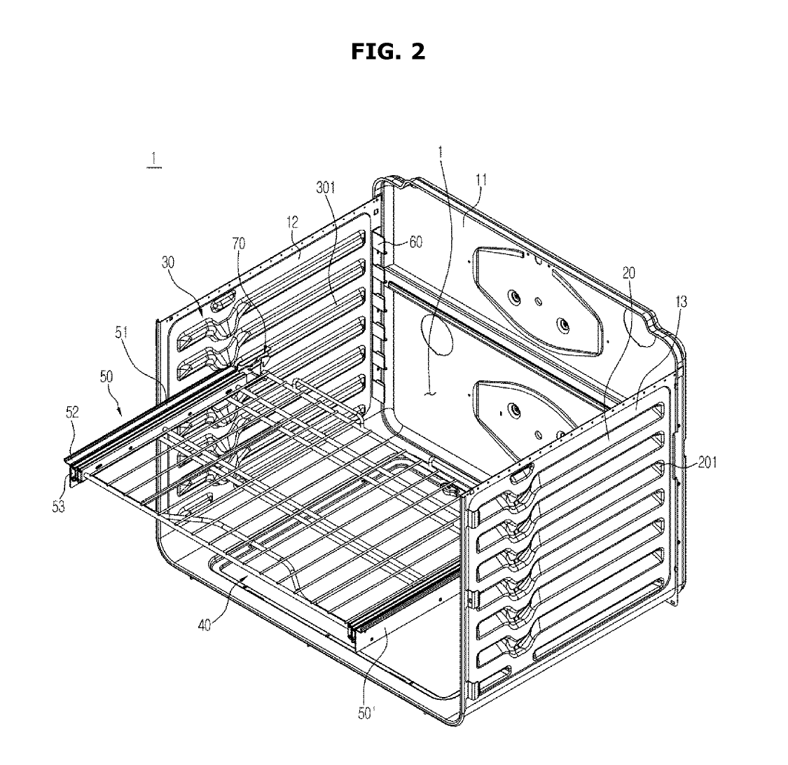

FIG. 1 is a perspective view illustrating a rack being accommodated inside of a cooking compartment in accordance with one or more embodiments. FIG. 2 is a perspective view illustrating the rack being withdrawn from the cooking compartment in accordance with one or more embodiments.

Referring to FIGS. 1 and 2, a cooking compartment 1 of a cooker in accordance with one or more embodiments may be provided with a rack 40 that may be able to be withdrawn from the cooking compartment 1. A rail assembly 50 may be mounted on the rack 40. The rack 40 may be slid by the rail assembly 50 so as to be inserted or withdrawn into/from the cooking compartment 1.

The cooking compartment 1 represents a space in which food that may be disposed on the rack 40 may be cooked. The rack 40 may be mounted may be the cooking compartment 1 so as to be configured to be withdrawn. The cooking compartment 1 may be provided at one side thereof with an opening, and a door (not shown) may be mounted on the cooking compartment 1 to open and close the opening. A user may insert or withdraw the rack 40 or food into/from the cooking compartment 1 through the opening (not shown) by opening the door (not shown).

A back plate 11 may be located at a rear side of the cooking compartment 1, and a first side plate 12 and a second side plate 13 may be located at both sides of the cooking compartment 1, that is, left and right sides of the cooking compartment 1, respectively. Hereinafter, a side of the cooking compartment 1, on which the opening may be located, is referred to as a front, a side of the cooking compartment 1, on which the back plate 11 may be located, is referred to as a rear side, a side of the cooking compartment 1, on which the first side plate 12 may be located, is referred to as a left side, and a side of the cooking compartment 1, on which the second side plate 13 may be located, is referred to as a right side.

The back plate 11, the first side plate 12 and the second side plate 13 may be integrally formed with one another in a U-shape, or may be separately formed from one another and coupled to one another. The back plate 11, the first side plate 12 and the second side plate 13 may be formed of material having a high thermal resistance and a low thermal conductivity. For example, the back plate 11, the first side plate 12 and the second side plate 13 may be formed of ceramic having a high thermal resistance and a low thermal conductivity.

The first side plate 12 and the second side plate 13 each may be provided with a plurality of rail mounting parts 30 and a plurality of rail mounting parts 20 protruding toward an inner side of the cooking compartment 1. The rail mounting parts 30 and 20 may be formed while extending from the front side to the rear side of the cooking compartment 1. The plurality of rail mounting parts 20 formed on the second side plate 13 may be provided to correspond to the plurality of rail mounting parts 30 formed on the first side plate 12. When the rail mounting part 20 and 30 are viewed from the outside the cooking compartment 1, the rail mounting part 30 may be shown as a groove recessed toward the inside of the cooking compartment 1.

When one of the rail mounting parts 30 formed on the first side plate 12 is referred to as a first rail mounting part 301, the rail assembly 50 provided at one side of the rack 40 may be slid while being mounted on the first rail mounting part 301. Similarly, the second side plate 13 may have a second rail mounting part 201 corresponding to the first rail mounting part 301, and a rail assembly 50′ provided the other side of the rack 40 may be slid while being mounted on the second rail mounting part 201.

A fixing bracket 60 may be mounted at a rear portion of each of the first side plate 12 and the second side plate 13. The fixing bracket 60 may be coupled to the first side plate 12 by a fastening member that passes through the first side plate 12 and the fixing bracket 60. The fixing bracket 60 may be coupled to the second side plate 13 by a fastening member that passes through the second side plate 13 and the fixing bracket 60. The coupling position and coupling method of the fixing bracket 60 according to one or more embodiments is not limited to the above description. As the rack 40 is mounted on the rail assembly 50, and a locking device 70 mounted on the rail assembly 50 is engaged with the fixing bracket 60, the rack 40 may be fixed while being accommodated inside the cooking compartment 60.

The rail assembly 50 and the rail assembly 50′ may be mounted at both sides of the rack 40, that is, a left side and a right side of the rack 40, respectively. The rail assembly 50 at the left side may be mounted on the rail assembly 30 formed on the first side plate 12, and the rail assembly 50′ at the right side may be slid while being mounted on the rail assembly 20 formed on the second side plate 12. As the rail assembly is slid along the rail mounting part 20, the rack 40 may be inserted or withdrawn into/from the cooking compartment 1.

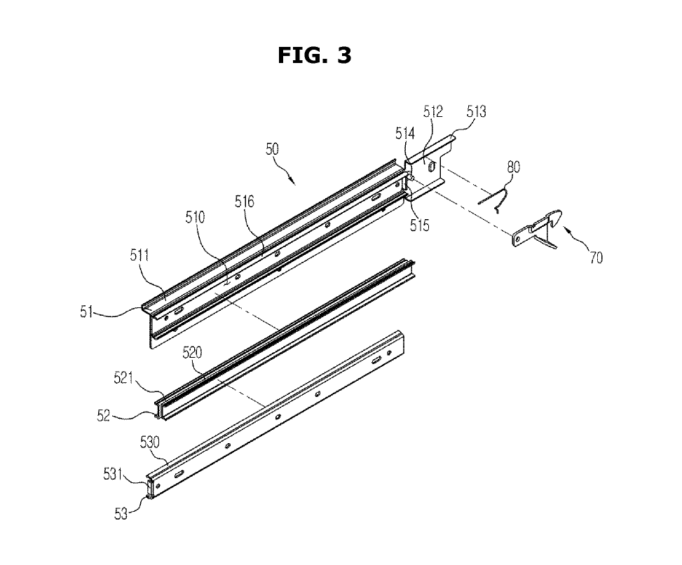

FIG. 3 is an exploded perspective view illustrating a rail assembly in accordance with one or more embodiments.

Referring to FIG. 3, the rail assembly 50 in accordance with one or more embodiments may include a fixing rail 51, an intermediate rail 52 and a moving rail 53. The intermediate rail 53 may be slid in a front and rear side direction along the fixing rail 51, and the moving rail 53 may be slid in a front and rear side direction along the intermediate rail 52. The intermediate rail 52 may be detachably installed on the fixing rail 51, and the moving rail 53 may be detachably installed on the intermediate rail 52. The rail assemblies 50 and 50′ may be installed at both side surfaces of the rack 40, respectively.

The locking device 70 may be mounted on the fixing rail 51 to possibly allow the rail assembly 50 to be fixed while being inserted into the cooking compartment 1.

The fixing rail 51 may be formed with an accommodation part 510 in which the intermediate rail 52 may be accommodated and slid. The accommodation part 510 may be formed by opening a side of the fixing rail 51 facing the inside of the cooking compartment 1 such that the intermediate rail 52 may be slid in a front and rear side direction. A guide part 516 may be provided at an upper side or a lower side of the accommodation part 510 by being bent from a portion of the fixing rail 51. A protrusion 517 may be formed at an inner surface of the guide part 516. The description of the protrusion 517 will be made later.

The fixing rail 51 may be provided at one side thereof with a mounting part 511 that may be mounted on the rail mounting parts 20 and 30. The mounting part 511 may be formed by bending a portion of the fixing rail 51.

The fixing rail 51 may be provided at one side thereof with a stopper 515 to possibly limit the movement of the intermediate rail 52. The stopper 515 may be formed by bending or protruding one end portion of the fixing rail 51, or may be separately formed and then coupled to the fixing rail 51. The stopper 515 may limit the moving distance of the intermediate rail 52 in the front or rear direction, and may prevent the intermediate rail 51 from being separated from the fixing rail 51.

The fixing rail 51 may be provided at one end portion thereof with a bracket coupling part 512. The bracket coupling part 512 may be provided with a rotating shaft 514 on which the fixing bracket 7 may be rotatably mounted. The rotating shaft 514 may be integrally formed by being protruded from the bracket coupling part 512, or may be separately formed and then coupled to pass through the locking device 70 and the bracket coupling part 512. The bracket coupling part 512 may be provided at one side thereof with a support part 513 to support an elastic member 80. For example, the support part 513 may be formed by bending a portion of an upper side end of the bracket coupling part 512 toward a side at which the locking device 70 is to be located.

The locking device 70 may be rotatably mounted on the rotating shaft 514. The elastic member 80 may be mounted on the bracket coupling part 512 to transmit an elastic force to the locking device 70.

The intermediate rail 52 may be slidably accommodated in the accommodation part 510 of the fixing rail 51. The intermediate rail 52 may have one side surface thereof facing one side surface of the fixing rail 51, and the other side surface thereof facing the moving rail 53. The intermediate rail 52 may be provided between the fixing rail 51 and the moving rail 53 to extend the withdrawn distance of the rack 40.

The intermediate rail 52 may be provided at an upper end portion or lower end portion thereof with a first guide part 521 facing the fixing rail 51 and a second guide part 521 facing the moving rail 53. A plurality of bearings 522 may be provided at an upper side of the first guide part 521 or an upper side of the second guide part 520 to possibly enable the intermediate rail 52 to be smoothly slid. The description of the bearings 522 will be made later.

The first guide part 521 may be accommodated in the accommodation part 510 of the fixing rail 51. An upper surface of the first guide part 521 may be provided to face a lower surface of the guide part 516 of the fixing rail 51. The second guide part 520 may guide the movement of the moving rail 53 that is to be described later.

The moving rail 53 may be provided with a guide part 530 formed by bending an upper end portion or lower end portion of the moving rail 53. The guide part 530 of the moving rail 53 may be slid while being mounted on the guide part 520 of the intermediate rail 52. The moving rail 53 or the intermediate rail 52 may be provided with a stopper to limit the moving rail 53 from moving in the front or rear side direction. For example, a stopper 531 may be provided by bending a front side end portion of the moving rail 53 to possibly limit the backward movement of the moving rail 53.

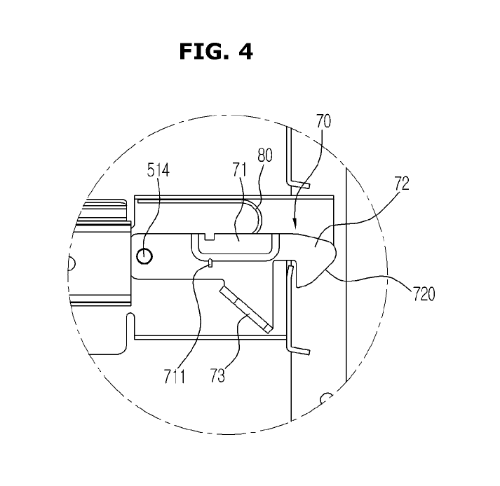

FIG. 4 is a drawing illustrating a locking device in accordance with one or more embodiments.

Referring to FIG. 4, the locking device 70 in accordance with one or more embodiments may include a body part 71, a head part 72 and an interference part 73. The head part 72 and the interference part 73 may extend from the body part 71, and may be integrally formed with the body part 71.

The body part 71 may be formed at one side thereof with a hole 710 allowing the rotating shaft 514 to be inserted thereinto. As the hole 710 is inserted around the rotating shaft 514 provided on the bracket coupling part 512, the locking device 70 may be rotatably coupled to the bracket coupling part 512.

The body part 71 may be formed at one side thereof with an elastic member coupling part 711 on which the elastic member 80 may be mounted. The elastic member 80 may transmit an elastic force in a direction of pushing to the body part 71 downwards. The elastic member 80 may be embodied using, for example, a wire spring. The elastic member coupling part 711 may be provided, for example, in the form of a groove allowing the elastic member 80 to be inserted thereinto. The elastic member 80 inserted into the groove to transmit an elastic force pushing the body part 71 downward.

The head part 72 may be formed at one end portion of the body part 71, and may be integrally formed with the body part 71. The head part 72 may be provided, for example, in the form of a hook. The head part 72 may include an inclination part 720. The inclination part 720 may be formed at a lower side of the head part 72. If the rail assembly 50 is completely inserted into the inside the cooking compartment 1, the head part 72 may be inserted into a fixing hole 620 formed through the fixing bracket 60.

The interference part 73 may be formed by protruding from a lower portion of the body part 71. The interference part 73 is interfered with by the fixing bracket 60 to prevent the rail assembly 50 from moving in the rear side direction. In detail, when the rail assembly 50 is slid in the rear side direction, the head part 72 may be inserted into the fixing hole 620 and the rail assembly 50 may be completely inserted into the inside the cooking compartment 1, the interference part 73 may be interfered with by the fixing bracket 60 to prevent the rail assembly 50 from further moving in the rear side direction, so that the rail assembly 50 may stop moving.

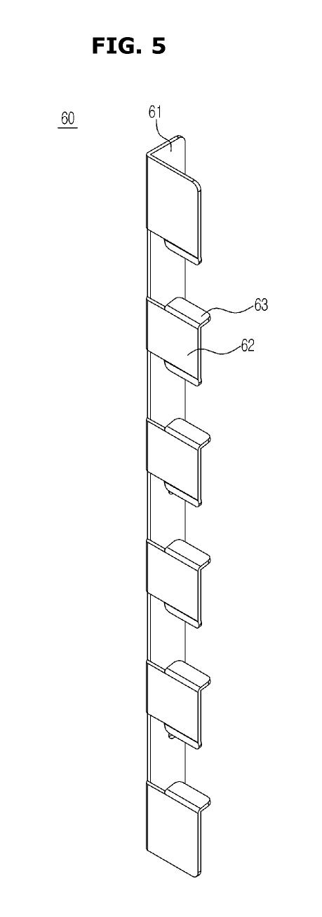

FIG. 5 is a drawing illustrating a fixing bracket in accordance with one or more embodiments.

Referring to FIGS. 1, 2 and 5, the fixing bracket 60 in accordance with one or more embodiments may include a coupling part 61, a fixing part 62 and a movement guide part 63. The fixing part 62 may be formed by extending from the coupling part 61 at a predetermined angle. The fixing part 62 may be provided to be spaced apart from the back plate 11 located at the rear side of the cooking compartment 1. Accordingly, the rail assembly 50 may be prevented from colliding with the back plate 11 even if being completely inserted into the inside the cooking compartment 1.

The coupling part 61 may be coupled to an inner wall of the cooking compartment 1. For example, the coupling part 61 may be coupled to the first side plate 12 or the second side plat 13. The coupling part 61 may be coupled to the first side plate 12 or the second side plate 13 through, for example, an adhesive member or a fastening member, etc. The method of coupling the coupling part 61 to the inner wall of the cooking compartment 1 is not limited thereto.

The fixing part 62 may be provided to correspond to the rail mounting parts 20 and 30. In detail, the fixing part 62 may be provided in a plurality of units thereof disposed in an upper and lower side direction such that the head part 71 of the locking device 70 may be locked with the fixing part 62 as the rail assembly 50 is slid along the rail mounting parts 20 and 30. As the inclination part 720 formed at the head part 71 of the locking device 70 is slid along an upper end portion of the fixing part 62 so that the head part 71 is located at a rear side of the fixing part 62, the rail assembly 50 may be fixed to the cooking compartment 1 by the fixing bracket 60.

The movement guide part 63 may be provided by extending from the fixing part 62. The movement guide part 62 may extend upwards while forming a predetermined angle with respect to the fixing part 62. As a user pushes the rail assembly 50 to the rear side to withdraw the rail assembly 50 from the cooking compartment 1, the locking device 70 may rotate the rotating shaft 514, so that the interference part 73 may be slid along the movement guide part 63.

Since the rail assembly 50 may be fixed while being inserted into the inside of the cooking compartment 1, by the locking device 70 and the fixing bracket 60, the locking device 70 and the fixing bracket 60 may be referred to as a fixing device.

Hereinafter, a method of fixing the rail assembly 50 to the inside of the cooking compartment 1 by using the locking device 70 will be described.

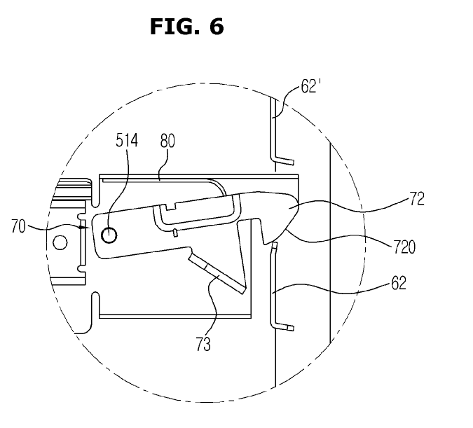

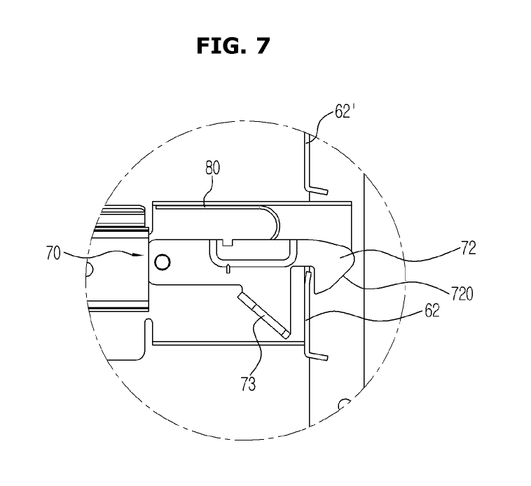

FIG. 6 is a drawing illustrating the locking device accessing the fixing bracket in accordance with one or more embodiments. FIG. 7 is a drawing illustrating the locking device fixed by being locked with the fixing bracket in accordance with one or more embodiments.

Referring to FIGS. 1, 6 and 7, when a user desires to insert the rack 40 into the cooking compartment 1, the user may allow the rail assembly 50 to be mounted on the rail mounting parts 20 and 30 and to be slid to the rear side. As the rail assembly 50 is slid along the rail mounting parts 20 and 30, the rack 40 may be moved to the inside of the cooking compartment 1. If the rail assembly 50 is slid to the rear side so that the head part 72 reaches the fixing part 62 of the fixing bracket 60, the inclination part 720 formed on the head part 72 may be slid along the upper end portion of the fixing part 62. As shown in FIG. 7, when the inclination part 720 is slid to a tip of the upper end portion of the fixing part 62, the head part 72 may be located at the rear side of the fixing part 62, and thus a forward movement of the head part 72 may be prevented by the fixing part 62. In this case, the locking device 70 may be fixed and prevented from be moved, by the elastic member 80. Accordingly, the rail assembly 50 may be fixed while being prevented from moved from inside the cooking compartment 1.

A state in which the head part 72 is engaged with the fixing part 62 is regarded that the rail assembly 50 is fixed inside the cooking compartment 1. As described above, the rail assembly 50 may be fixed inside the cooking compartment 1 while being prevented from being moved in the front and rear side direction unless an external force is applied by the locking device 70. In addition, the fixing bracket 60 may have a plurality of fixing parts 62 disposed in the upper and lower side direction, thereby possibly limiting the movement of the locking device 70 in the upper and lower side direction. Accordingly, the movement of the rail assembly 50 and the rack 40 in the upper and lower side direction may be limited. Since the movement of the rack 40 in the upper and lower side direction and the front and rear side direction may be limited by the structures of the locking device 70 and the fixing bracket 60, the user may stably dispose and cook the food in a state that the rack 40 is fixed inside the cooking compartment 1.

Hereinafter, a method of withdrawing the rail assembly 50 from the cooking compartment 1 will be described.

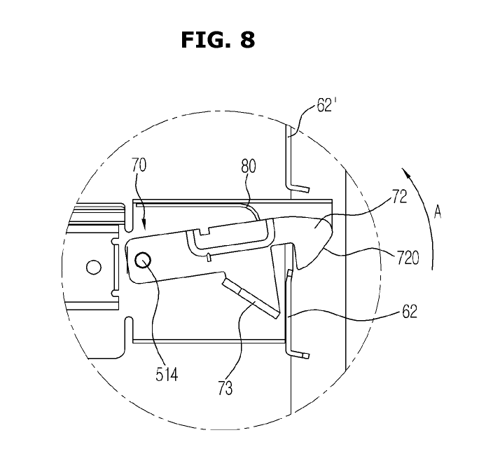

FIG. 8 is a drawing illustrating the locking device released from being fixed to the fixing bracket in accordance with one or more embodiments.

Referring to FIGS. 2 and 8, when a user desires to withdraw the rack 40 from the cooking compartment 1, the user may release the fixed state of the rail assembly 50 by applying a force to move the rack 40 backward, and then withdraw the rack 40.

As the rail assembly 50 is pushed backward together with the rack 40, the interference part 73 may make contact with the fixing part 62 and the locking device 70 may rotate on the rotating shaft 514 in a direction A. In this case, the rail assembly 50 may be given a force greater than the elastic force of the elastic member 80. As the locking device 70 rotates in the direction A, the head part 72 may move upward and thus may be located at a space between the fixing part 62, which has fixed the head part 72, and a nearby fixing part 62′ located at an upper side of the fixing part 62. As the user pulls the rack 40 forward, the head part 72 may escape from the space between the fixing part 62 and the nearby fixing part 62′, and thus the rack 40 may be withdrawn in a state that the head part 72 is released from the fixed state.

As described above, a user may withdraw the rack 40 by releasing the fixed state of the rail assembly 50.

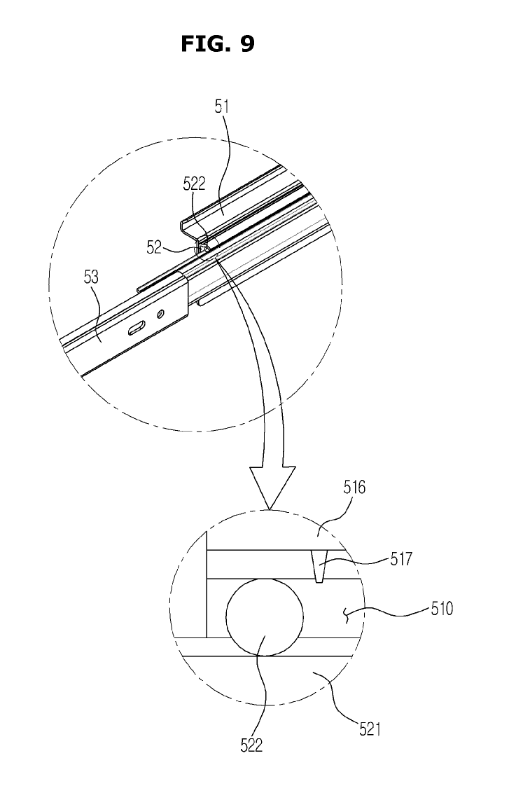

FIG. 9 is a drawing illustrating a protrusion formed at the rail assembly in accordance with one or more embodiments.

Referring to FIG. 9, at least one of the fixing rail 51, the intermediate rail 52 and the moving rail 53 included in the rail assembly 50 in accordance with one or more embodiments may be provided with a protrusion. Another one of the fixing rail 51, the intermediate rail 52 and the moving rail 53, which may be slid while coming into contact with the at least one of the fixing rail 51, the intermediate rail 52 and the moving rail 52 having the protrusion, may be provided with a bearing that may be interfered with by the protrusion. Through the structures of the protrusion and the bearing, the rack 40 may be fixed while being withdrawn.

For example, a protrusion 517 may be provided at an inner side of the guide part 516 of the fixing rail 51. The protrusion 517 may be provided at an upper portion or a lower portion of the inner side of the guide part 516. The protrusion 517 may be provided at an inner side of the guide part 516 provided at the front side of the cooking compartment 1.

The intermediate rail 52 may be provided at an upper surface or a lower surface thereof with the plurality of bearings 522 such that the intermediate rail 52 may be smoothly slid. The bearing 522 may be a ball bearing, for example. The protrusion 517 may protrude to possibly interfere with a part of the bearing 522. In a case in which the intermediate rail 52 is slid along the guide part 516 of the fixing rail 51, the bearing 522 may be interfered with by the protrusion 517.

When a user withdraws the rack 40 by sliding the intermediate rail 52, the bearing 522 may be interfered with the protrusion 517 and thus the intermediate rail 52 may be fixed without being slid unless an external force is present. For example, when a cooker is installed on a slanted floor, if a user withdraws the rack 40 by sliding the intermediate rail 52, the bearing 522 may be interfered with the protrusion 517 and thus the intermediate rail 52 may be fixed in a state of being withdrawn, so that the user may put or take foods in/out of the rack 40. If a user slides the intermediate rail 52 backwards by applying an external force to insert the rack 40 to the inside of the cooking compartment 1, the bearing 522 may pass through the protrusion 517. The feedback given when a user inserts the rack 40 into the cooking compartment 1 improves the sensation of use.

While aspects of the present invention have been particularly shown and described with reference to differing embodiments thereof, it should be understood that these embodiments should be considered in a descriptive sense only and not for purposes of limitation. Descriptions of features or aspects within each embodiment should typically be considered as available for other similar features or aspects in the remaining embodiments. Suitable results may equally be achieved if the described techniques are performed in a different order and/or if components in a described system, architecture, device, or circuit are combined in a different manner and/or replaced or supplemented by other components or their equivalents.

Thus, although a few embodiments have been shown and described, with additional embodiments being equally available, it would be appreciated by those skilled in the art that changes may be made in these embodiments without departing from the principles and spirit of the invention, the scope of which is defined in the claims and their equivalents.

What is claimed is:

1. A cooker comprising:
a cooking compartment;
a fixing bracket mounted at an inner wall of the cooking compartment;
a rack provided so as to be withdrawn from the cooking compartment;
a rail assembly mounted on the rack and enabling the rack to be inserted and withdrawn from the cooking compartment; and
a locking device mounted on the rail assembly, and having one side locked with the fixing bracket such that the rail assembly is fixed inside the cooking compartment.

2. The cooker of claim 1, wherein the cooking compartment comprises a back plate located at a rear side and side plates located at both sides.

3. The cooker of claim 2, wherein the fixing bracket is mounted at one side plate.

4. The cooker of claim 1, wherein the fixing bracket comprises a coupling part mounted at the side plate, and a fixing part extending from the coupling part.

5. The cooker of claim 4, wherein the fixing part is formed by being bent from the coupling part, and provided in a plurality thereof being spaced apart from one another.

6. The cooker of claim 5, wherein the locking device comprises a head part, which extends from a body part of the locking device and comprises an inclination part at a lower portion of the head part.

7. The cooker of claim 6, wherein the inclination part slidably passes past the fixing part as the rail assembly is slid to inside the cooking compartment, and the rail assembly is fixed as the head part is disposed at a rear side of the fixing part.

8. The cooker of claim 7, wherein an elastic member is mounted on the rail assembly, and the elastic member transmits an elastic force to the locking device, thereby fixing the locking device.

9. The cooker of claim 6, wherein the body part is formed with a hole and the rail assembly is provided with a rotating shaft inserted into the hole.

10. The cooker of claim 9, wherein the locking device further comprises an interference part extending from a lower portion of the body part,
wherein when the rail assembly is slid to the rear side of the cooking compartment while being fixed to the inside of the cooking compartment by the locking device, the locking device rotates on the rotating shaft such that the interference part slides to an upper side of the fixing part and the head part is located above fixing part.

11. The cooker of claim 10, wherein the rack is withdrawn from the cooking compartment by pulling the rail assembly to a front side of the cooking compartment when the head part is located above the fixing part.

12. The cooker of claim 1, wherein the rail assembly comprises a fixing rail, an intermediate rail configured to slide while being mounted on the fixing rail, and a moving rail configured to slide while being mounted on the intermediate rail.

13. The cooker of claim 12, wherein a bearing is mounted on at least one of the fixing rail, the intermediate rail and the moving rail, and a protrusion is formed on another one of the fixing rail, the intermediate rail and the moving rail that is slid while coming into contact with the at least one of the fixing rail, the intermediate rail and the moving rail which has the bearing.

14. The cooker of claim 13, wherein the locking device is coupled to the fixing rail, and the rack is mounted on the moving rail.

15. The cooker of claim 5, wherein the side plate is provided with a rail mounting part protruding in a front and rear side direction, and the rail assembly is slid along the rail mounting part.

16. The cooker of claim 15, wherein the fixing part is provided to correspond to the rail mounting part, and when the rail assembly is slidably inserted along the rail mounting part, the locking device is locked with the fixing part.

17. A cooker comprising:
a cooking compartment;
a fixing rail configured to slide while coming into contact with an inner wall of the cooking compartment;
an intermediate rail configured to slide while being mounted on the fixing rail;
a moving rail configured to slide while being mounted on the intermediate rail;
a fixing bracket mounted on the inner wall of the cooking compartment, and comprising a plurality of fixing parts provided at a rear side of the cooking compartment while being spaced apart from an inner wall; and
a locking device mounted on the fixing rail, and configured to fix the fixing rail by being engaged with the fixing part.

18. The cooker of claim 17, wherein the fixing rail is provided with a rotating shaft formed in a protruding manner, and the locking device is mounted so as to rotate on the rotating shaft.

19. The cooker of claim 17, wherein an elastic member is mounted on the fixing rail so as to provide the locking device with a downward elastic force, thereby preventing the locking device from being moved.

20. The cooker of claim 19, wherein a bearing is mounted on at least one of the fixing rail, the intermediate rail and the moving rail, and a protrusion is formed on another one of the fixing rail, the intermediate rail and the moving rail that is slid while coming into contact with the at least one of the fixing rail, the intermediate rail and the moving rail which has the bearing.

21. A rack for a cooker comprising:
a rail configured to slide while coming into contact with an inner wall of a cooker;
a rack mounted on the rail;
a fixing bracket mounted on the inner wall of the cooking compartment, and comprising a plurality of fixing parts provided at a rear side of the cooking compartment while being spaced apart from an inner wall; and
a locking device mounted on the rail, and configured to fix the rail by being engaged with the fixing part.

22. The cooker of claim 21, wherein the rail is provided with a rotating shaft formed in a protruding manner, and the locking device is mounted so as to rotate on the rotating shaft.

23. The cooker of claim 21, wherein an elastic member is mounted on the rail so as to provide the locking device with a downward elastic force, thereby preventing the locking device from being moved.
